(19) United States
(12) Patent Application Publication
(10) Pub. No.: US 2012/0247576 A1
(43) Pub. Date: Oct. 4, 2012

(54) Container For Fluid Operating Materials Of A Motor Vehicle

(75) Inventors: Christoph Lind, Gleisdorf (AT); Robert Gratz, Wagrain (AT); Gregor Wasle, Reutte (AT); Paul Fletcher, Schwarzach (AT)

(73) Assignee: ALUTECH GESELLSCHAFT M.B.H., Lend (AT)

(21) Appl. No.: 13/515,532

(22) PCT Filed: Nov. 9, 2010
(86) PCT No.: PCT/AT10/00429

§ 371 Date: Jun. 13, 2012

(30) Foreign Application Priority Data
Dec. 17, 2009 (AT) A 2000/2009

(51) Int. Cl. F16L 53/00

(52) U.S. Cl. 137/334

(57) ABSTRACT

The invention relates to a container for fluid operating materials of a motor vehicle, comprising at least one container and a heat-exchanging device outside said container. The heat-exchanging device is formed by two half-shells sitting against the container wall outside said container, said half-shells having an inner wall and an outer wall which between at least one flow channel is formed for a heat-transferring medium.

The present invention relates to receptacles for operating fluids of a motor vehicle, comprising at least one container and a heat exchanger unit outside the container, which heat exchanger unit is connected to an external heat source or heat sink. The operating fluid can be a liquid, a paste-like material or free-flowing granules.

Modern motor vehicles with removal of nitrogen oxide from the exhaust gases of an internal combustion engine or alternative, in particular hybrid, drives require storage containers for an operating agent. Such operating agents are, for example, animal fats, rape oils or hydrides. To ensure optimum effectiveness, these operating agents are temperature-controlled. To this end, a heating or cooling system must be provided.

In the prior art, such containers are fitted with separate heat exchanger units which are either housed inside the container or situated outside the container and which are connected to the inside of the container via tubing. However, it is time- and cost-consuming to manufacture the former and time- and cost-consuming to install the latter, with the latter also being bulky. This expenditure is all the more objectionable in that, as a rule, only relatively small quantities of heat have to be supplied or discharged.

Thus, the problem to be solved by the present invention is to design a receptacle of the type described in such a manner that it can be manufactured and installed easily and inexpensively, including in mass production, while ensuring that it fully performs its intended function. According to the present invention, this is made possible in that the heat exchanger unit is formed by two half-shells which lie against the container wall and which have an inside and an outside wall, between which walls at least one flow channel for a heat carrier medium is formed. The container can be conventionally designed without any built-in components. All that is necessary is to provide one half-shell on each side. Since half-shells do not entail any tolerance problems, it is possible to easily retrofit the heat exchanger unit. The use of half-shells ensures a large-surface and consequently uniform heat transfer. The two half-shells can be easily manufactured and installed.

In one embodiment of the present invention, the edges of the half-shells are connected to one another. To this end, in an especially simple variant, these edges are crimped outward, and the edges of the two half-shells that face each other engage in a rail which holds them together. In an advanced embodiment of this variant, at least one rail is divided along its longitudinal direction into two rail portions which are detachably connected to each other. This ensures an especially easy installation and deinstallation.

The half-shells can be made of a sheet metal material or an extruded profile. Depending on the circumstances and the number of pieces to be manufactured, one or the other embodiment is to be preferred. In the first embodiment, the half-shells are formed by an inner sheet metal panel and an outer sheet metal panel, with the inner sheet metal panel lying against the wall of the container in a thermally conductive manner and with the outer sheet metal panel having convexities that form the flow channel or flow channels and being sealingly connected between the convexities with the inner sheet metal panel. This embodiment can be produced inexpensively since only the outer sheet metal panel needs to be deep-drawn and since the two shells are identical.

The two sheet metal panels can be connected by welding or gluing. In an advanced embodiment of this variant, the outer sheet metal panel has pipe sockets for supplying and discharging the heat carrier medium.

With a slight additional expenditure, the half-shells can be designed so as to largely enclose two, or even a plurality of, containers that are arranged parallel to one another in the same manner.

In the second embodiment, the half-shells are double-walled extruded profiles, the two walls of which are connected to each other by means of a number of joining strips which extend in the longitudinal direction (=direction of extrusion) and which form the flow channel or flow channels. Owing to the joining strip walls, the extruded profile can be cut off at right angles relative to the direction of extrusion and installed without requiring any other action. A lid is attached along the cut faces. This lid can be designed to ensure that it connects the individual flow channels to one another in any manner desired.

In a useful advanced embodiment of the present invention, individual joining strip walls can be shortened, for example, by means of milling, so as to connect the flow between neighboring flow channels. The lid can be a simple plane plate to which pipe sockets are to be attached so as to provide a connection for supplying and discharging a heat carrier medium.

In addition, the lid can engage in the cut face of the two half-shells so as to interlock and thus establish the connection between the paired half-shells. Lastly, the lid can be reduced to a closed ring, the contour of which follows the contour of the two half-shells.

This embodiment is especially recommended for grouping a plurality of containers in one receptacle. To this end, the outside wall of the extruded profile can form a plane subsurface, with the plane subsurfaces of the half-shells of a plurality of containers lying against either the subsurface of a neighboring container or a housing of the receptacle. In this case, the hollow spaces between the individual containers can be filled with an insulating material.

The present invention will be explained below with reference to the accompanying drawings. As can be seen:

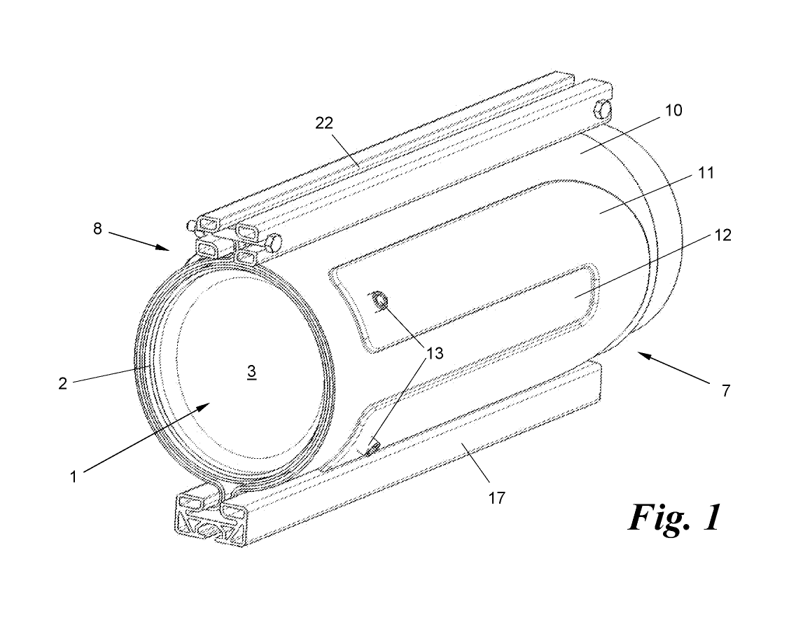

FIG. 1 shows an axonometric view of a first embodiment of a receptacle according to the present invention;

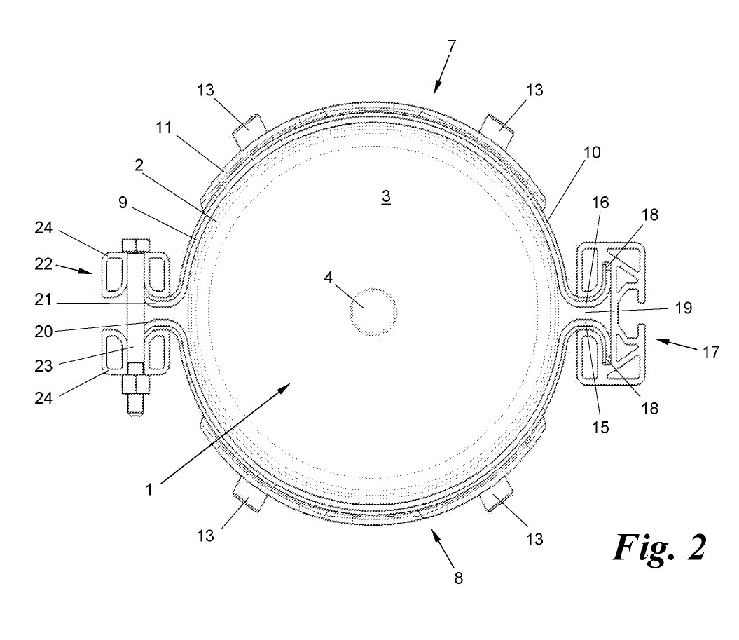

FIG. 2 shows a cross section through the receptacle shown in FIG. 1;

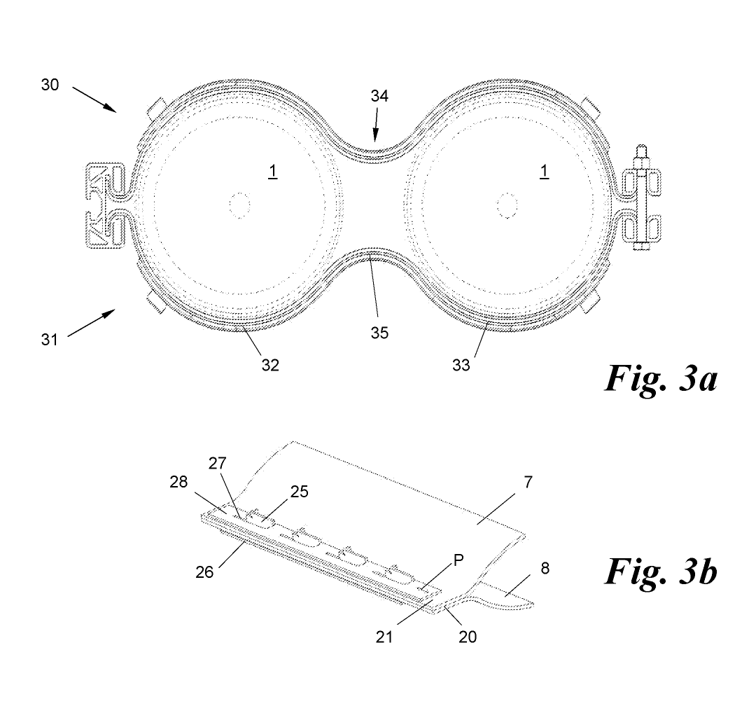

FIG. 3a shows a cross section through a variant of FIG. 2;

FIG. 3b show a variant of the connection of the half-shells shown in FIG. 2;

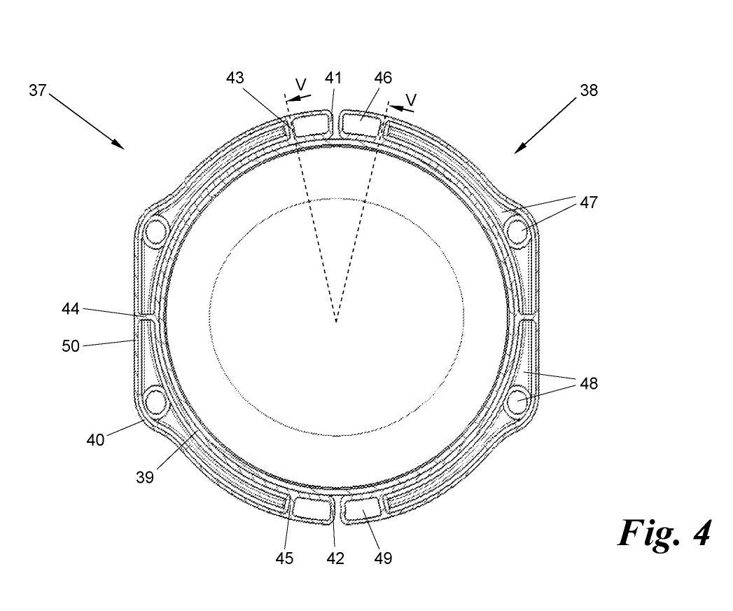

FIG. 4 shows a cross section through a second embodiment of the invention as shown in FIG. 2;

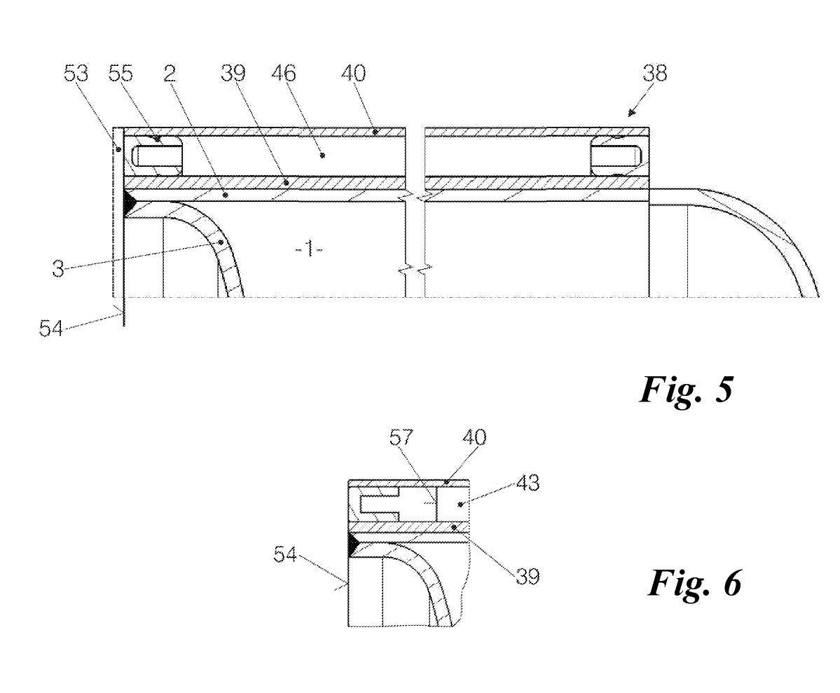

FIG. 5 shows a longitudinal section along V-V in FIG. 4;

FIG. 6 shows a longitudinal section along VI-VI in FIG. 4;

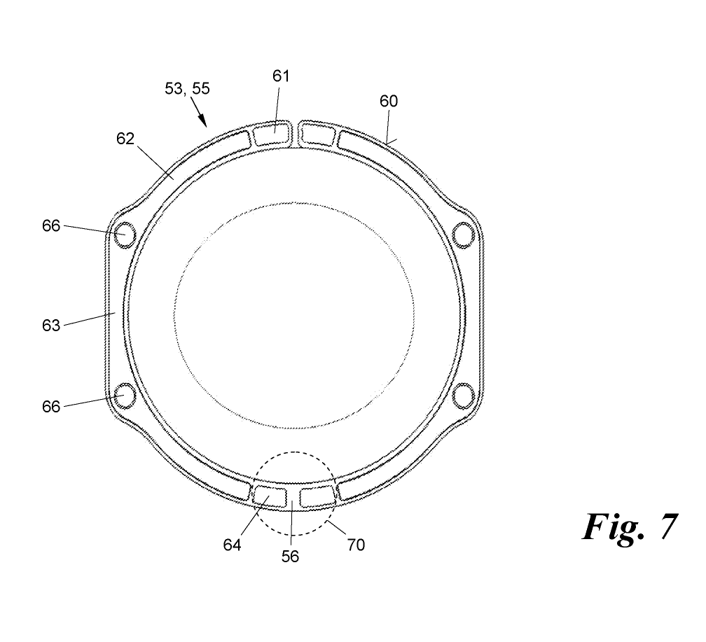

FIG. 7 shows a view of the inside of the lid in the direction of sight VII in FIG. 5; and

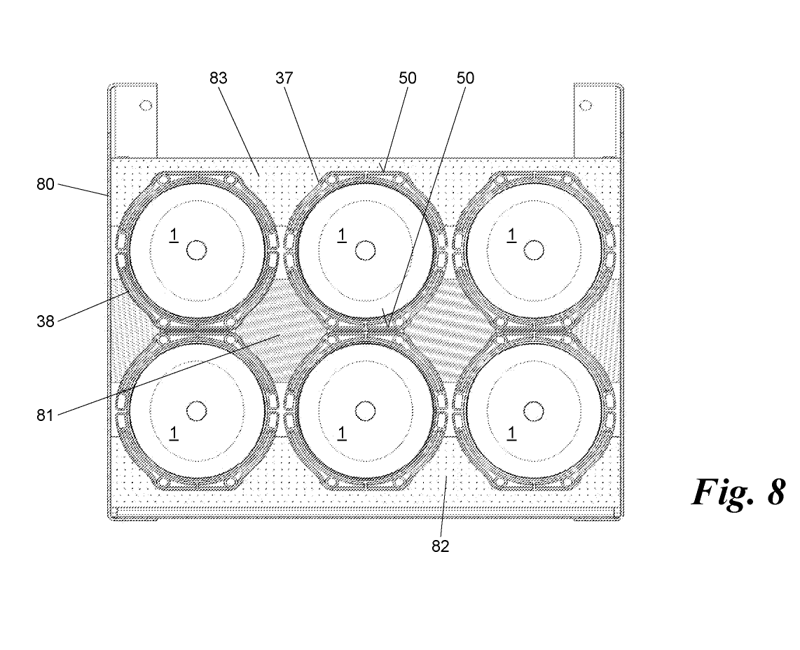

FIG. 8 is a variant of FIG. 4.

In FIGS. 1 and 2, a container is designated with 1. It comprises a cylindrical wall 2 and round cavities 3, only one of which has a visible pipe socket 4 that serves to dispense the content of the container. The container 1 is surrounded by two half-shells 7, 8 that have a substantially semi-cylindrical shape. The half-shells 7, 8 are identical and therefore only one of them will be described. The half-shell 7 is formed by a substantially cylindrical inner sheet metal panel 9 that sits close to the wall 2 of the container and an outer sheet metal panel 10. The outer sheet metal panel 10 is a drawn metal part which has a basic cylindrical shape and which has raised surface portions 11 to form a flow channel which (in this case) has the shape of a U. The surface portions 12 that are not raised are sealingly connected, for example, welded, preferably glued, to the inner sheet metal panel 9. In the vicinity of the ends of the flow channel, sockets 13 are attached so as to make it possible to supply and discharge a heat carrier medium.

For attachment to the container 1, the longitudinal edges 15, 16 of the half-shells 7, 8 are crimped or chamfered outwardly in the shape of a U. The longitudinal edges 15, 16 that face each other engage by way of a longitudinal slit 19 in the longitudinal grooves 18 of a rail 17. In this case, the rail 17 is an extruded profile. The longitudinal edges 20, 21 on the other side of the container 1 can be held together by a rail 22 that is identical to rail 17. In this case, however, the rail 22, in the longitudinal direction, is divided into two subrails 24 which are tensioned relative to each other by thread bolts 23. This facilitates the installation of the half-shells 7, 8 and ensures that they are tightly seated on the container.

In the variant according to FIG. 3a, two containers 1 are disposed side by side and are jointly enveloped by two half-shells 30, 31. The cylindrical parts 32, 33 of these half-shells sit close to the containers 1, and the intermediate area 34 has a cylindrical necked-down portion 35 so as to enlarge the contact surface.

FIG. 3b shows an alternative embodiment for connecting the longitudinal edges 20, 21 of the half-shells 7, 8. In this embodiment, the longitudinal edges 20, 21 sit close to each other and are jointly penetrated by locking hooks 25 of a first locking rail 26, which locking hooks can interlock in the slits 27 of a second locking rail 28 that can be moved in the direction of arrow P.

In the second embodiment according to FIGS. 4 and 5, the two half-shells 37, 38 are extruded profiles. Each half-shell is simply the extruded profile cut to the appropriate length. It comprises an inside wall 39, an outside wall 40, the peripheral walls 41, 42 and a number of joining strip walls 43, 44, 45. This is the manner by which flow channels 46, 47, 48, 49 are formed. The outside wall of the extruded profile is substantially cylindrical, but it may have a plane subsurface 50.

In the longitudinal section shown in FIG. 5, the dashed line defines a lid 53 that is attached to the axially normal cut face 54 of the half-shell 38. The lid can cover only one of the half-shells or both half-shells 37, 38. The lid can also be reduced to a ring portion 55 that engages in the flow channels 46, 47, 48, 49 and thus sealingly encloses these channels. The section in FIG. 6 shows that the joining strip wall 43 is milled beginning at the cut face 54 inwardly up to an edge 57 so as to create a transfer of the heat carrier medium from one flow channel 46 into the neighboring flow channel 47.

FIG. 7 shows the lid 53 (or the ring portion 55) from the inside. Its outer contour continuously follows the contour of the half-shells 37, 38. Its raised islands 61, 62, 63, 64, or only some of them, fit into the end zones of the flow channels 46, 47, 48 and/or 49. Boreholes 66 serve to supply and discharge the heat carrier medium. A variant visible in the dashed circle 70 shows that the ring portion 55 overlaps the edges of the half-shells 37, 38 at 56 and thus connects them to each other.

In FIG. 8, six containers 1 with heat exchanger units as in FIG. 4 are combined in a block to form a receptacle. A housing 80 of the receptacle, which can simply be a frame, which housing can be attached inside a motor vehicle, comprises the individual containers 1 with their heat exchanger units which, owing to their flattened subsurfaces 50, are positioned and stacked in the housing 80. Thus, a container 1, e.g., with the flattened subsurface 50 of its heat exchanger unit, sits close to the housing 80, on the one hand, and to the flattened subsurface 50 of a neighboring container 1 and its heat exchanger unit, on the other hand. The hollow spaces 81, 82, 83 between the containers 1 are filled with an insulating material.

The invention is not limited to the practical examples described, but comprises all variants and modifications that fall within the scope of the attached claims.

What is claimed is:

1. A receptacle for operating fluids of a motor vehicle, comprising at least one container and a heat exchanger unit outside the container, wherein the heat exchanger unit is formed by two half-shells which lie against the outside of the container wall and which have an inside wall and an outside wall, between which walls at least one flow channel for a heat carrier medium is formed.

2. The receptacle of claim 1, wherein the longitudinal edges of the half-shells, which edges face each other, are connected to each other.

3. The receptacle of claim 2, wherein the longitudinal edges of the half-shells, which edges face each other, are crimped outwardly, and that each edge engages in a rail that holds them together.

4. The receptacle of claim 3, wherein at least one rail in the longitudinal direction is divided into two subrails which subrails are detachably connected to each other.

5. The receptacle of claim 1, wherein the half-shells are formed by an inner sheet metal panel and an outer sheet metal panel, with the inner sheet metal panel lying against the wall of the container in a thermally conductive manner and with the outer sheet metal panel having convexities that form the flow channel(s) and being sealingly connected between the convexities with the inner sheet metal panel.

6. The receptacle of claim 5, wherein the outer sheet metal panel comprises pipe sockets for supply and discharge of heat carrier medium.

7. The receptacle of claim 5, wherein the half-shells receive two containers that are disposed parallel to each other.

8. The receptacle of claim 1, wherein the half-shells are double-walled extruded profiles, the two walls of which are connected to each other via a plurality of joining strip walls which extend in the longitudinal direction and which form the flow channel(s).

9. The receptacle of claim 8, wherein on both front ends, the extruded profiles are closed by one lid each, with individual joining strip walls being shortened so as to connect the flow between neighboring flow channels.

10. The receptacle of claim 9, wherein the lid engages in a front end of the two half-shells that are associated with one container so as to interlock with it, said front end being at right angles relative to the direction of extrusion, and thus establishes the connection between the associated half-shells.

11. The receptacle of claim 10, wherein the lid is a closed ring, the contour of which follows the contour of the two half-shells.

12. The receptacle of claim 9, wherein the lid has openings for supply and discharge of heat carrier medium.

13. The receptacle of claim 1, wherein the outside wall of the extruded profile forms a plane subsurface.

14. The receptacle of claim 13, wherein the receptacle comprises a plurality of containers with the plane subsurfaces lying against either the subsurface of a neighboring container or a housing of the receptacle.

15. The receptacle of claim 14, wherein the hollow spaces between the individual containers are filled with an insulating material.
